(19) United States
(12) Patent Application Publication
(10) Pub. No.: US 2015/0002781 A1
(43) Pub. Date: Jan. 1, 2015

(54) SUNLIGHT READABLE LCD DEVICES EMPLOYING A DISPLAY SHUTTER

(71) Applicant: YAO-DONG MA, Frisco, TX (US)

(72) Inventor: YAO-DONG MA, Frisco, TX (US)

(21) Appl. No.: 13/931,867

(22) Filed: Jun. 29, 2013

(51) Int. Cl. G02F 1/1335

(52) U.S. Cl. CPC G02F 1/1336
USPC 349/62

(57) ABSTRACT

The current invention relates to sunlight readable full color active matrix liquid crystal display devices. By means of an electric controllable light shutter, both the internal backlight and the external sunlight can be used for lighting the display so as to deliver superior readability and color quality. The display shutter, including passive and active light shutter, can be also worked as the second display.

### FIELD OF THE INVENTION

The current invention relates to sunlight readable full color active matrix liquid crystal display devices. By means of an electric controllable display light shutter, both the internal backlight and the external sunlight can be used for lighting the display so as to deliver superior readability and color quality. The display shutter, including passive and active light shutter, can be also worked as the second display.

### BACKGROUND OF THE INVENTION

In today's information age, portable electronic display devices for people on the go, such as notebook computer, lap top computer, hand-held computer, tablet and smart phone and etc., have become more and more popular around the world. Internet cloud computing, wireless communication, multimedia and nano-semiconductor technologies as well as software applications are boosting those computers as ultra mobile viewing terminals more vigorously in the new century.

Currently, one of the arguments in the electronic display field is that whether we are in the so called post-PC era or the PC+ era. What is the ideal device for the future, PC or tablet? But people tend to ignore the most important factor of the device: visual quality. For example, a touch panel on the top of a display panel as designed in many tablet products makes such screen's readability unacceptable under the sunlight environment. Users suffer not only from eye strain but also from fatigue as looking at the screen under sunshine. The ideal technological innovation should enable users to carry a single device that is as portable and usable as a tablet but also as powerful and capable as a PC, which has not only a superior readability both in indoor and outdoor applications but also a battery that can last all day.

From display point of view, there are two remaining issues for the current portable devices: poor screen readability and limited color capability when they are viewed under sunshine.

There has been developed a LED backlit transflective LCD for the last few years. The basic structure is that there is a reflective metal layer that covers almost whole pixel area except one hole in each individual pixel structure. It is only the hole area which allows the backlight passing through the color filter and attributes the full color display effect, therefore the LCD works in a color display mode in indoor applications. However, its color saturation is not as good as traditional full color TFT display. In case of outdoor usage, on the other hand, the display works in a black-and-white mode due to the sunlight reflection of the metal layer. Such insufficient color quality in transmission mode and black-and-white sunlight reflection mode has limited its applications. Furthermore, it might not be feasible to produce a small size but high resolution display.

Other LCD companies around the world produce transflective full color displays with a semi-transparent metal layer underneath the color filter structure. Obviously, the use of thin metal layer remarkably reduces the display's brightness and transmission in the indoor backlight mode. And the color quality of the display under the sunshine is not satisfactory, either.

In the U.S. Pat. No. 7,427,140, the applicant discloses a sunlight readable direct-view and projection-view computing device, which is herein incorporated by reference. When the computing device works in the direct-view mode, the display panel tilts up to the conventional display position and it has a wide, open viewing angle; when it works in the projection view mode, the display panel tilts down and forms a projection image via a minor plate with a sufficient high contrast ratio and superior readability even directly under sunshine.

In the U.S. Pat. No. 7,853,288, the applicant discloses a sunlight illuminated and sunlight readable mobile phone, which is herein incorporated by reference. The display panel opens a transparent window to the ambient light, which allows the sunlight to illuminate the display in both indoor and outdoor applications. A light collecting panel is introduced to reflect the external light with a suitable angle relative to the display panel.

### SUMMARY OF THE INVENTION

It is the primary objective of this invention to create a user-friendly sunlight readable full color display device.

It is another objective of this invention to create a superior readability both in indoor and outdoor applications.

It is still another objective of this invention to use a passive TFT LCD light shutter with two reflective linear polarizers to control both the internal backlight and the external sunlight.

It is again the objective of this invention to design one optical state of the light shutter to reflect all the light back to the internal backlighting; and the other one optical state to guide the sunlight as an external backlight into the display panel.

It is another objective of this invention to use a passive bistable cholesteric liquid crystal light shutter display with predetermined handedness.

It is yet another objective of this invention to use an active AMOLED light shutter to control both the internal light and the external sunlight.

It is a further objective of this invention to create a dual display mode.

It is another objective of this invention to maintain the advantageous liquid crystal display performances and enrich such display into outdoor application so as to prolong the life cycle of the LCD.

It is again the objective of this invention to create high contrast and clear images for touch panel display devices.

### BRIEF DESCRIPTION OF THE DRAWINGS

FIG. 1 illustrates a schematic sunlight readable liquid crystal display employing a nematic liquid crystal light shutter.

FIG. 2 illustrates a schematic sunlight readable liquid crystal display employing a cholesteric liquid crystal light shutter.

FIG. 3 illustrates a schematic sunlight readable liquid crystal display employing a power-free reflective cholesteric display.

FIG. 4 illustrates a schematic sunlight readable liquid crystal display employing a double-view display mode.

FIG. 5 illustrates a schematic sunlight readable liquid crystal display employing an AMOLED light shutter.

### DETAILED DESCRIPTION

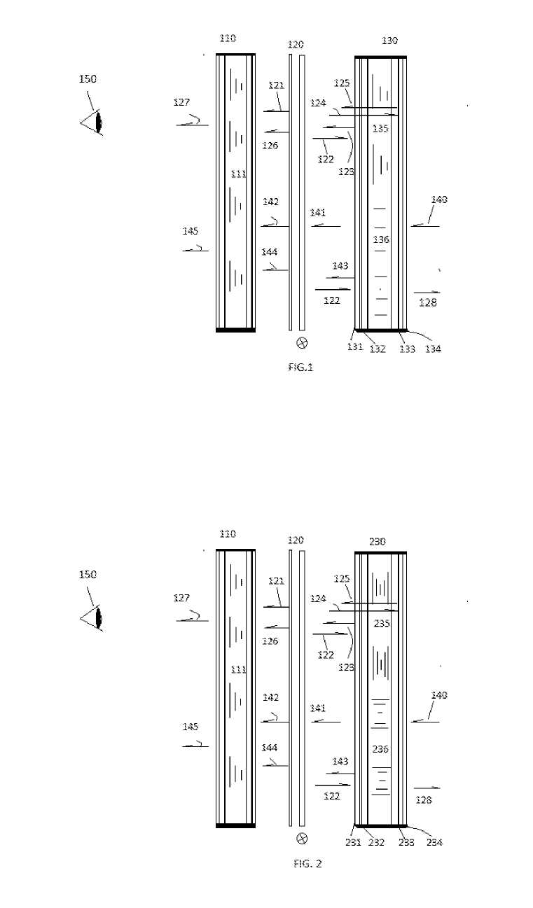

Referring first to FIG. 1, illustrated is a schematic sunlight readable liquid crystal display employing a nematic liquid crystal shutter. An electric controllable TFT twist nematic liquid crystal display structure 130 allows a pure internal backlight as the backlit source in the first controllable LC texture 135 and sunlight or ambient light as the backlit source in the second controllable LC texture 136. The LCD structure 130 includes two layers of reflective linear polarizer 131 and 133 and two layers of absorptive linear polarizer 132 and 134 laminated onto the opposite side of the display cell substrates, wherein the reflective linear polarizer 131 and the absorptive linear polarizer 132 with the first polarity are attached on the first substrate; and the reflective linear polarizer 133 and the absorptive linear polarizer 134 with the second polarity are attached on the second substrate. A conventional built-in backlight structure 120 is a multi-layer congregation consists of LED bar, light guide panel, front diffuser and light enhancement film. A TFT LCD panel 110 includes an active matrix LCD cell structure 111, polarizers and electronic connecter. The internal backlight 120, located between two LCDs 110, 130 is a common backlit source of them. Both display's rigid or flexible PC board and related video cable should be clear from the pixel area. Any opaque components should not be wrapped up to block the effective pixels from the illumination of the external lighting. A capacitive or resistive touch panel may also be attached to the front surface of the display panel.

Different from the prior art LCD, the present invention introduces the novel LCD 130 employing two reflective polarizers for its substrates, while the two absorptive polarizers work as clean-up polarizers for their corresponding reflective polarizers. Thus, the display 130 is structured as both light shutter and display panel. The liquid crystal inside of the display 130 can be a bistable nematic mode or mono-stable twist nematic mode, both of the bistable and the mono-stable twist nematic modes are well-known in the field.

Please note that one of the substrates of the display, either made of plastic or glass, should not be including a traditional absorptive R.G.B color filter structure in order to achieve maximum reflection and transmission. However, R.G.B.W (Red.Green.Blue.White) color filter structure, which has decent reflection and transmission, may be adopted for color LCD 130. In this case it is highly recommended that the display 110 should also be structured with R.G.B.W color filter instead of R.G.B. color filter.

Display Mode I

In this mode, liquid crystal molecules are addressed in a nematic texture 135. The display works in a pure internal backlight mode.

When an artificial light 122 out of the built-in backlight structure hits on the first reflective polarizer 131 with the same polarity, it will be bounced back to form the light 123, for example, horizontal polarized light. On the other hand, when a beam of artificial light 124 out of the built-in backlit structure has the opposite polarity to the first reflective polarizer, for example vertical polarizing light, it will pass through the reflective polarizer 131 and the absorptive polarizer 132 and enter into the display's twist nematic area 135. Then it will be wave-guided 90 degrees by the liquid crystal 135 into horizontal polarized light and be reflected by the second horizontal reflective polarizer 133. Reverse light wave-guide effect of the liquid crystal leads the light out of the display as a vertical polarizing light 125. As a result, both horizontal and vertical polarized backward light 123 and 125 from the backlighting unit will pass through backlight 120 as the light 126. Thus, both the forward portion of the backlight light 121 and the light 126 will contribute to the illumination of the LCD 110. Finally, a viewer 150 will sense the color imaging light 127 out of the display 110.

Display Mode II

In this mode, liquid crystal molecules are addressed in a homeotropic texture 136. The display works in a sunlight-readable internal and external lighting mode.

When the light 122 hits on the first reflective polarizer 131 with the same polarity, it will be bounced back to form the light 143, for example, horizontal polarized light. Then the light 143 passes through the internal backlight unit as a partial polarization 144. On the other hand, when a beam of artificial light out of the built-in backlit structure has the opposite polarity to the first reflective polarizer, for example, vertical polarizing light, it will pass through the reflective polarizer 131 and the absorptive polarizer 132 and enter into the display's homeotropic area 136, wherein its vertical polarization will remain unchanged. Then it proceeds to pass through the second horizontal reflective polarizer 133 and the absorptive horizontal polarizer 134 and leaves the display as a vertical polarizing light 128.

Meanwhile, when the sunlight or the external ambient light 140 passes through the absorptive polarizer and reflective polarizer, it becomes a polarized light. In the homeotropic liquid crystal area 136, such polarization will substantially remain its optical state and further travel through the absorptive polarizer 132 and reflective polarizer 131 as the light 141. After passing through the internal backlight unit, the light 141 becomes a partially polarized light 142.

Please note that both light 142 and 144 will contribute to the readability of the display in the form of light 145. In indoor application, the latter 144 plays a dominate role to the viewer, like a conventional display device. In outdoor application, on the other hand, especially under the sunshine, the former 142 will be many times brighter than the latter. Therefore, color images under sunlight can be as clear as that in indoor environment even if a touch panel is attached to the display device. In a cloudy weather condition, such joint illumination makes display images vivid and comfortable to the viewer.
Most importantly, the present invention creates a dual backlighting mode, which remarkably improves the performance of display devices. One of the advantageous properties of the present invention is that the inside backlight and environmental sunlight is totally compatible. The synergistical lighting can meet various displays' illuminating requirements no matter in the indoor condition, in the dark cloudy condition or in the sunlight exposing condition. The other advantageous property of the present invention is that it will be applicable to most portable and mobile devices wherein the transition from indoor to outdoor is inevitable. Users will feel comfortable for such a seamless transition between inside and outside of the building because the imaging quality will be remaining almost the same. A sensor may be embedded into the device to shut down the internal backlight during the sunny outdoor application just like an auto sensor in a car lighting system wherein the transition is hardly discernable. Thus it will prolong the working hours of the battery and the device itself.

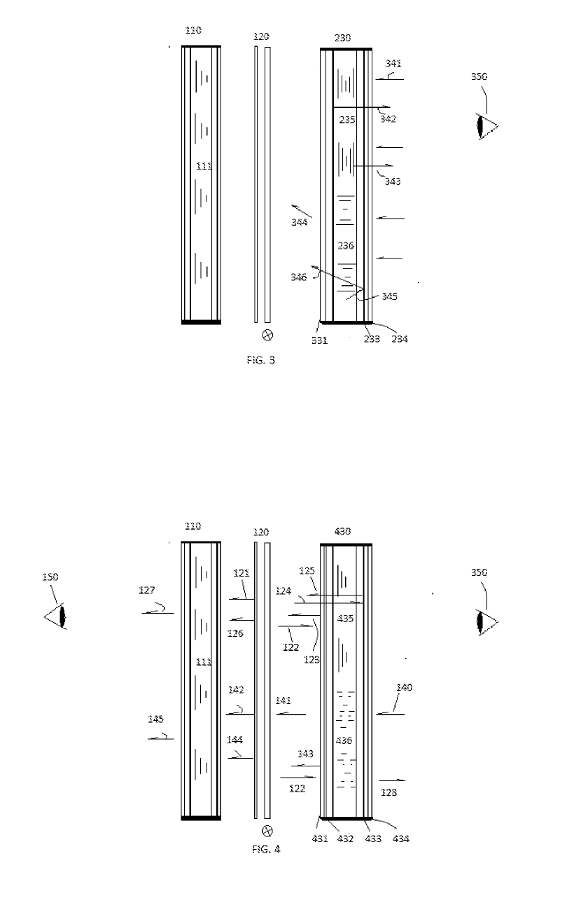

Turning now to FIG. 2, illustrated is a schematic sunlight readable liquid crystal display employing a cholesteric liquid crystal shutter. An electric controllable cholesteric liquid crystal display (CLCD) structure 230 allows a pure internal backlight to be the backlit source in the cholesteric planar texture 235 and sunlight or ambient light to be the backlit source of the display in the cholesteric focal conic texture 236. The CLCD structure 230 includes two layers of reflective circular polarizer 231 and 233 and one layer of absorptive circular polarizer 234 laminated on the opposite side of the display cell substrates, wherein the reflective circular polarizer 231 with the first polarity, for example right-handed polarization, is attached on the first substrate; and the reflective circular polarizer 233 and the absorptive circular polarizer 234 with the second polarity, for example left-handed polarization, are attached on the second substrate. A conventional built-in backlight structure 120 is a multi-layer congregation consists of LED bar, light guide panel, front diffuser and light enhancement film. A TFT LCD panel 110 includes an active matrix LCD cell structure 111, polarizers and electronic connecter. Both display's rigid or flexible PC board and related video cable should be clear from the pixel area. Any opaque components should not be wrapped up to block the effective pixels from the illumination of the external lighting. A capacitive or resistive touch panel may also be attached to the front surface of the display panel.

The present invention introduces the novel CLCD 230 employing two reflective circular polarizers for its substrates. Thus, the display 230 is structured as both light shutter and display panel. Please note that one substrate of the display, either made of plastic or glass includes a reflective cholesteric color filter structure 232 in order to achieve a reflective color CLCD.

Display Mode I

In this mode, liquid crystal molecules are addressed in a cholesteric planar texture 235. The display works in a pure internal backlight mode.

When an artificial light 122 out of the built-in backlight structure hits on the first reflective circular polarizer 231 with the same polarity, it will be bounced back to form the light 123, for example, right-handed circular polarized light. On the other hand, when a beam of artificial light 124 out of the built-in backlit structure has the opposite polarity to the first reflective polarizer, for example left-handed circular polarizing light, it will pass through the reflective polarizer 231 and enter into the display's planar area 235. Then it will be reflected by the second left-handed reflective polarizer 233 and finally travels out of the display as a left-handed circular polarizing light 125. As a result, both left-handed and right-handed circular polarized light 123 and 125 will pass through backlight 120 as the light 126. The forward portion of the backlight light 121 and the light 126 will join together and contribute to the illumination of the LCD 110. Therefore, a viewer 150 will sense the color imaging light 127 out of the display 110.

Display Mode II

In this mode, liquid crystal molecules are addressed in cholesteric focal conic texture 236. The display works in a sunlight-readable internal and external lighting mode.

When the light 122 hits on the first reflective circular polarizer 231 with the same polarity, it will be bounced back to form the light 143, for example, right-handed circular polarized light. Then the light 143 passes through the internal backlight unit as a partial polarization 144. On the other hand, when a beam of artificial light out of the built-in backlit structure has the opposite polarity to the first reflective polarizer, for example left-handed circular polarizing light, it will pass through the reflective polarizer 231, the cholesteric color filter 132 and enter into the display's focal conic area 236, wherein a depolarization takes place due to the randomness of the focal conic texture. Part of it will pass through the second left-handed reflective circular polarizer 233 and the absorptive circular polarizer 234 and leave the display as a polarizing light 128.

Meanwhile, when the sunlight or the external ambient light 140 passes through the absorptive circular polarizer 234 and reflective circular polarizer 233, it becomes a circular polarized light. In the focal conic texture area 236, such polarization will be substantially depolarized into a mixture of right-handed and left-handed polarized light, wherein the left-handed portion will further travel through the color filter 232 and reflective polarizer 231 as light 141. After passing through the internal backlight unit the light 141 becomes a partial polarization 142.

Please note that both light 142 and 144 will contribute to the readability of the display in the form of light 145. In indoor application, the latter 144 plays a dominant role to the viewer, like a conventional display device. In outdoor application, on the other hand, especially under the sunshine, the former 142 will be many times brighter than the latter. Therefore, the outdoor color image can be as clear as indoor environment even when a touch panel is attached to the display device. In a cloudy weather condition, such joint illumination makes display images vivid and comfortable to the viewer.

Please also note that, due to the intrinsic bistability of the CLCD, there will be no any power consumption after the shutter being addressed into either the planar state or the focal conic state. It is well-known in the liquid crystal field that cholesterics has two stable states, wherein the first stable state is the planar texture after applying a higher voltage and back to zero voltage in a fast way and the second stable state is the focal conic texture after applying a low voltage level to CLCD. Starting from a pure planar texture, CLCD can be addressed into partial planar texture and partial focal conic mixture, a multi-stable coexistent state.

Therefore, the present invention creates a dual backlighting mode, which remarkably increases performances of display devices. One of the advantageous properties of the present invention is that the inside backlight and environmental sunlight is totally compatible. This means that the synergistical lighting can meet various displays' illuminating requirements no matter in the indoor condition, in the dark cloudy condition or in the sunlight exposing condition. The other advantageous property of the present invention is that it will be applicable to most portable and mobile devices wherein the transition from indoor to outdoor is inevitable. Users will feel comfortable for such a seamless transition between inside and outside of the building because the imaging quality will be remaining almost the same. A sensor may be embedded into the device to shut down the internal backlight during the sunny outdoor application just like an auto sensor in a car lighting system wherein the transition is hardly discernable. Thus it will prolong the working hours of the battery and the device itself.

Turning now to FIG. 3, illustrated is a schematic sunlight readable front-lit liquid crystal display employing a power-free reflective cholesteric liquid crystal display. Basically, the display structure is the same as FIG. 2, except the fact that a viewer 350 is on the opposite side of the display structure and that the internal backlight is set in OFF state. Now, the display works in a black-and-white e-book mode, which is described as follows.

Display Mode III

The controllable CLCD 230 has a circular polarity of a predetermined handedness as it is addressed in an ON state 235. On the other hand, when the controllable CLCD is in an OFF state 236, it depolarizes the incident light and scatters the light optically, as a result, a substantial portion of the incident light 341 becomes forward-scattered.

The display includes a reflective circular polarizer 233 and an absorptive circular polarizer 234, located approximately at the first substrate. These polarizers are selected to have the same handedness as the CLCD has. Those skills in the art recognize that a circular polarizer transmits the portion of incident light that has the same polarity as the polarizer. Likewise, the polarizer functions as an “analyzer” for the portion of incident light that has the opposite polarity as the polarizer; e.g. a right-handed polarizer is a left-handed analyzer, which blocks (either absorbed or reflected) all incident light that is left-circular polarized. The display also includes a reflective circular polarizer 331, located approximately at the second substrate with an opposite handedness that the CLCD has.

Having described the structure of front-lit monochrome CLCD, the operation may now be described such that the principle of the technology may be fully understood. For illustration purposes, it is assumed that the CLCD is selected such that, when it is driven to planar state 235, the incident light 341 having wavelengths within the CLCD's intrinsic spectral bandwidth of reflection and the same handedness as the CLCD will be reflected as the light 343; all remaining wavelengths out of the Bragg reflection is transmitted through the CLCD, then reflected by the reflective circular polarizer 331 and finally passed through the front reflective circular polarizer 233 as well as the absorptive circular polarizer 234 as the light 342. As a result, two portions of the reflections, light 342 and 343 construct a full spectrum white color in display's ON state.

When the display is in an OFF state, the light transmitted through the front circular polarizer is optically scattered and depolarized by the CLCD's focal conic texture 346. The portion of the incident light that is forward-scattered is emitted from the controllable focal conic structure at substantially all angles. Half of it will pass through the circular polarizer 331 as the light 344, and the other half of it will be reflected by the circular polarizer 331 as the light 345. The reflected portion of the light in the focal conic texture will be further attenuated by the front circular polarizer 233 and 234 as the light 346. Thus, for the region of the monochrome display that is in an OFF state, a substantial portion of the incident light is not perceived by an observer 350. The display, in this particular area, takes on an optical dark state.

The display has long-term memory and it requires no additional power to maintain an image. Addressing an image and taking away the power, the image will stay bright and clear in room light or sunlight conditions.

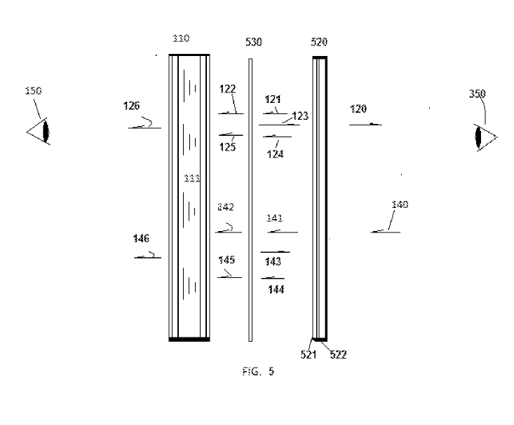

Turning now to FIG. 4, illustrated is a schematic sunlight readable liquid crystal display with double-side-view capability.

Basically, the display structure is the same as FIG. 1, except the fact that images can be perceived from either side of the display (one-side-view) or from two sides of the display simultaneously (double-side-view). A viewer 150 will sense a full color LCD image in indoor and outdoor sunlight environment. On the other hand, a viewer 350 will sense a black-and-white image or a color image in indoor environment (e-book mode). Furthermore, if the display 430 is tuned in field sequential electric controlled birefringence mode and correspondingly, the backlit 120 is chosen as a RGB full color LED light, the viewer 350 will sense a full color display image in indoor environment.

The fundamental difference between the state of the art and the prior art LCD is that the present invention introduces the novel LCD 430 employing two reflective polarizers 431 and 433, while the two absorptive polarizers 432 and 434 work as clean-up polarizers for their corresponding reflective polarizers. Thus, the display 430 is structured as both a light shutter and a display panel. As the above-mentioned e-book mode, the viewer 350 will be able to perceive a reflective black-and-white nematic display without using the internal backlight if the clean-up absorptive polarizer 432 is omitted.

Moreover, when a reflective color filter is placed on the top of the clean-up polarizer 432, the viewer 350 will perceive a reflective full color nematic display without using the internal backlight. Thus, the e-book mode can be a full color nematic display.

The present invention employs a controllable liquid crystal shutter as a sunlight transmitter for sunlight readable display devices. However, the state of the art technology is not limited to above-mentioned displays. Broadly speaking, the principle will be applicable to all other LC shutters such as polymer dispersed liquid crystal, bistable twist nematic liquid crystal, smectic liquid crystal and so on.

Turning now to FIG. 5, illustrated is a schematic sunlight readable liquid crystal display with an AMOLED as the internal backlighting source.

Basically, the liquid crystal display structure is the same as FIG. 1, except the fact that its backlighting is provided by the AMOLED display 520 and enhanced by a reflective polarizer as a light enhancement film 530. Images can be perceived from either side of the display (one-side-view) or from two sides of the display simultaneously (double-side-view). A viewer 150 will sense a full color LCD image in indoor and outdoor sunlight environment. On the other hand, a viewer 350 will sense a full color image in indoor environment.

The fundamental difference between the state of the art and the prior art LCD is that the present invention introduces the novel AMOLED display as the lighting source of the LCD, while the AMOLED itself is the second display panel.

Display Mode I

In this mode, the AMOLED display 520 set in full spectrum white lighting state, while the liquid crystal display 110 works in a pure internal backlight mode.

When an artificial light 121 out of the AMOLED display 520 hits on the reflective polarizer 530, the portion with opposite polarity will be passing through it as the light 122 and the other portion with the same polarity will be bounced back to form the light 123. Then the light 123 will be reflected by the AMOLED to form the light 124, which further passing through the reflective polarizer as the light 125. Thus, both the forward portion of the light 122 and the light 125 will contribute to the illumination of the LCD 110. Finally, a viewer 150 will sense the color imaging light 126 out of the display 110.

Display Mode II

In this mode, the AMOLED display 520 set in power-off black state. The display 110 works in a sunlight-readable external lighting mode.

When the sun light 140 hits on the substantially transparent AMOLED 520, it will pass through to form the light 141. Then the natural light 141 out of the AMOLED display 520 will proceed to hit on the reflective polarizer 530, wherein the portion with opposite polarity will be passing through it as the light 142 and the other portion with the same polarity will be bounced back to form the light 143. The latter will be reflected by the AMOLED to form the light 144, which further passing through the reflective polarizer 530 as the light 145. Thus, both the forward portion of the light 142 and the light 145 will contribute to the illumination of the LCD 110. Finally, a viewer 150 will sense the natural color imaging light 146 out of the display 110.

Display Mode III

In this mode, the AMOLED display 520 is set in display ON state. And the display 110 is set display OFF state, i.e., power-free normal-white transparent state. A viewer 350 will sense the color imaging light 120 out of the display 520. Since there is no traditional backlight assembly involved in the display structure, the display 110 is substantially transparent. Therefore, the viewer 150 will be able to sense the color image 126 out of the AMOLED display 520, so long as the image is converted from the reverse mode to the normal mode by the image controller (not shown in the FIG. 5). Please note that this display mode requires a precise alignment and registration between the display 110 and display 520 and the reflective polarizer film 530 can be omitted without disturbing the principle of the current invention.

1. A sunlight readable LCD device comprising:
a. a controllable nematic display panel;
b. an internal backlight panel;
c. a controllable nematic shutter display panel with two reflective polarizers;
wherein the nematic display panel is attached to one side of the backlight panel while the nematic shutter display is positioned to the other side of the backlight panel;
wherein the nematic shutter display panel reflects internal backlight to the nematic display panel via reflective polarizers at the first optical state and introduces a substantial external light and internal backlight at the second optical state;
whereby the LCD generates full color images with sufficient brightness and contrast under the outdoor sunlight as well as the indoor ambient light.

2. The sunlight readable LCD device as claimed in claim 1 wherein the controllable nematic display panel is a full color transparent TFT LCD.

3. The sunlight readable LCD device as claimed in claim 1 wherein the controllable nematic shutter display panel is a black-and-white TN TFT LCD.

4. The sunlight readable LCD device as claimed in claim 1 wherein the controllable nematic shutter display panel is a bistable nematic TFT LCD.

5. The sunlight readable LCD device as claimed in claim 1 wherein the reflective polarizer is linear reflective polarizer.

6. The sunlight readable LCD device as claimed in claim 1 wherein the shutter display panel includes at least one layer of absorptive clean-up polarizer.

7. The sunlight readable LCD devices as claimed in claim 1 wherein the nematic shutter display panel is a sunlight transmitter in the homeotropic optical state.

8. The sunlight readable LCD devices as claimed in claim 1 wherein the nematic shutter display panel is an internal backlight reflector in the nematic optical state.

9. A sunlight readable LCD device comprising:
a. a controllable nematic display panel;
b. an internal backlight panel;
c. a controllable cholesteric shutter display panel with two reflective polarizers;
wherein the nematic display panel is attached to one side of the backlight panel while the cholesteric shutter display panel is placed on the other side of the backlight panel;
wherein the first optical state of the cholesteric shutter display reflects internal backlight to the nematic display panel and the second optical state of the cholesteric shutter display panel introduces external light to the nematic display panel, resulting in a uniform illumination of the nematic display panel;
wherein the cholesteric shutter display works as power-free reflective display;
whereby images can be displayed from at least one side of the LCD with sufficient brightness and contrast under the outdoor sunlight as well as the indoor ambient light.

10. The sunlight readable LCD devices as claimed in claim 9 wherein the cholesteric shutter display panel is a bistable cholesteric display.

11. The sunlight readable LCD device as claimed in claim 9 wherein the reflective polarizer is circular reflective polarizer.

12. The sunlight readable LCD devices as claimed in claim 9 wherein the cholesteric shutter display further including a cholesteric reflective color filter.

13. The sunlight readable LCD devices as claimed in claim 9 wherein the cholesteric shutter display panel is a power-free sunlight transmitter in the focal conic optical state.

14. The sunlight readable LCD devices as claimed in claim 9 wherein the cholesteric shutter display panel is a power-free internal backlight reflector in the planar optical state.

15. A sunlight readable LCD device comprising:
a. a controllable LC shutter display panel;
b. a controllable AMOLED shutter display panel;
wherein in the first LC shutter display state, the first optical state of the AMOLED display provides internal backlight to the LC display panel and the second optical state of the AMOLED display panel introduces external light to the LCD panel, resulting in uniform illuminations of the LCD panel;
wherein in the second LC shutter display state, the AMOLED display works in the third optical state;
whereby images can be displayed from at least one side of the display with sufficient brightness and contrast under the outdoor sunlight as well as the indoor ambient light.

16. The sunlight readable LCD devices as claimed in claim 15 wherein the first LC shutter display state is a full color display state.

17. The sunlight readable LCD devices as claimed in claim 15 wherein the second LC shutter display state is a power-free transparent state.

18. The sunlight readable LCD devices as claimed in claim 15 wherein the first optical state of the AMOLED shutter display is a full spectrum white lighting state.

19. The sunlight readable LCD devices as claimed in claim 15 wherein the second optical state of the AMOLED shutter display is a power-off black state.

20. The sunlight readable LCD devices as claimed in claim 15 wherein the third optical state of the AMOLED shutter display is a full color display state.
